(19) United States
(12) Patent Application Publication
(10) Pub. No.: US 2024/0127366 A1
(43) Pub. Date: Apr. 18, 2024

(54) SOCIAL VALUE EVALUATION APPARATUS, SOCIAL VALUE EVALUATION METHOD AND PROGRAM

(71) Applicant: NIPPON TELEGRAPH AND TELEPHONE CORPORATION, Tokyo (JP)

(72) Inventors: Takashi FURUTANI, Tokyo (JP); Akira TAKEUCHI, Tokyo (JP); Yuriko TANAKA, Tokyo (JP)

(73) Assignee: NIPPON TELEGRAPH AND TELEPHONE CORPORATION, Tokyo (JP)

(21) Appl. No.: 18/555,843

(22) PCT Filed: Apr. 20, 2021
(86) PCT No.: PCT/JP2021/016056

§ 371 Date: Oct. 17, 2023

(51) Int. Cl. G06Q 50/00; G06F 40/40

(52) U.S. Cl. CPC G06Q 50/01; G06F 40/40

(57) ABSTRACT

Provided is a social value evaluation device, including:
a feature value generation unit configured to generate a feature value from text information on social value evaluation;
an input unit configured to input text information on an evaluation target;
an evaluation unit configured to evaluate a relevance between the feature value and the text information input by the input unit; and
an output unit configured to output an evaluation result from the evaluation unit.

### TECHNICAL FIELD

The present invention relates to a technology for evaluation social value of, for example, a company.

### BACKGROUND ART

Non-financial information of corporations, represented by ESG (standing for “Environment, Society and Governance”), is nowadays considered as one of the most important factors to evaluate a social value of a company.

Economic value, i.e. financial information (e.g. profits and ROI) has been the central criteria to identify material risks and growth opportunities of a company, for example, for investments. However, recently, investors have increasingly applied non-financial factors such as ESG and SDGs as part of their analysis to screen investments in a company based on its social value. On the other hand, corporate activities have emerged focusing on corporate social responsibility rather than economic value of a company, as in Grameen Bank.

### CITATION LIST

### Non Patent Literature

[NPL 1] 2018 Environmentally Sustainable Corporate Assessment Committee (1st) “Example of ESG Rating Methodology”, Mitsubishi UFJ Research & Consulting, http://www.env.go.jp/policy/j-hiroba/kigyo/R1/ESGkakudukeGirei.pdf, [retrieved on Apr. 8, 2021]

### SUMMARY OF INVENTION

### Technical Problem

These days, ESG metrics for impact investors (a.k.a. “ESG indices”) are generally used for measuring a benchmark of a company exhibiting the best corporate social responsibility. However, ESG indices are determined on the basis of publicly available company information (updated annually, for example), and details of rating schema and processes are different and not disclosed. Moreover, since the information is updated infrequently, a relevance between ESG indices and daily financial information cannot be clearly rated.

The public information of a company updated, for example, once a year is usually prepared by external consultants, and thus it is allegedly based on subjective evaluation. Consequently, it is not clear whether ESG policies (for example, framework for SDGs) in the public information reflect the actual corporate activities.

The present invention has been made for such a problem, and an object of the present invention is to provide a technology capable of evaluating a social value of an evaluation target company reflecting its actual corporate activities.

### Solution to Problem

According to the present disclosure, a social value evaluation device includes:
a feature value generation unit configured to generate a feature value from text information on social value evaluation;
an input unit configured to input text information on an evaluation target;
an evaluation unit configured to evaluate a relevance between the feature value and the text information input by the input unit; and
an output unit configured to output an evaluation result from the evaluation unit.

### Advantageous Effects of Invention

According to the present disclosure, it is possible to provide a technology capable of evaluating social value of an evaluation target company reflecting its actual corporate activities.

### BRIEF DESCRIPTION OF DRAWINGS

FIG. 1 is a diagram illustrating a conventional evaluation method.

FIG. 2 is a diagram illustrating an overview of an embodiment.

FIG. 3 is a diagram illustrating an overview of an embodiment.

FIG. 4 is a diagram illustrating a configuration of a social value evaluation device.

FIG. 5 is a diagram illustrating a hardware configuration example.

FIG. 6 is a diagram illustrating an image of a feature value calculation.

FIG. 7 is a flowchart of processing.

FIG. 8 illustrates examples of financial information.

FIG. 9 is a diagram illustrating an output example.

FIG. 10 is a diagram illustrating an output example.

FIG. 11 is a diagram illustrating an output example.

FIG. 12 is a diagram illustrating an output example.

### DESCRIPTION OF EMBODIMENTS

Hereinafter, an embodiment of the present invention (the present embodiment) will be described with reference to drawings. The embodiment described below is a mere example and embodiments in which the present invention is implemented are not limited to the following embodiment.

For example, a company is assumed as an evaluation target for social value in the following embodiment, but the technology according to the present invention can be applied to other cases where the evaluation target is not a company. For example, the technology according to the present invention may be applicable to, for example, a person, a group, a country, or a local government. Moreover, processing is performed for Japanese text in the following embodiment; however it is a mere example, and the technology according to the present invention can be applicable to any language.

### Problem and Overview of Embodiment

As described above, ESG indices are often used when evaluating a social value of a company in the prior art. However, the ESG indices have an uncertainty of whether they reflect the actual corporate activities varying from time to time. This challenge will be described referring to a conventional example of ESG rating.

As disclosed in “MSCI ESG Research: ESC Ratings Methodology Summary” (MSIC, 2017), for example, the convention ESG rating framework is configured such that key issues are selected and weighted for each industry, and companies are rated by scoring exposure metrics (how exposed the company is to each material issue) and management metrics (how the company is managing each material issue). Key issues scores are obtained from those two metrics.

Each company further receives an Industry-Adjusted Score, which is defined by the weighted average of its scores normalized based on score ranges in order to assess the company's performance relative to its industry peers. Based on the Industry-Adjusted Score, the company's ESG rating is determined.

The ESG rating process mentioned above uses the latest available information as provided by companies as sources, for example, annual reports such as a sustainability report.

However, it is not possible to enable sufficient evaluation of frequently updated non-financial factors, such as a framework for SDGs, only based on the public information disclosed annually. Moreover, external consultants are usually involved in preparing the public information of a company, thus it is unclear whether the actual conditions are accurately reflected.

A social value evaluation device 100 of the present embodiment is intended to solve the problems stated above, which is capable of evaluating social value accurately reflecting the actual corporate activities in real time.

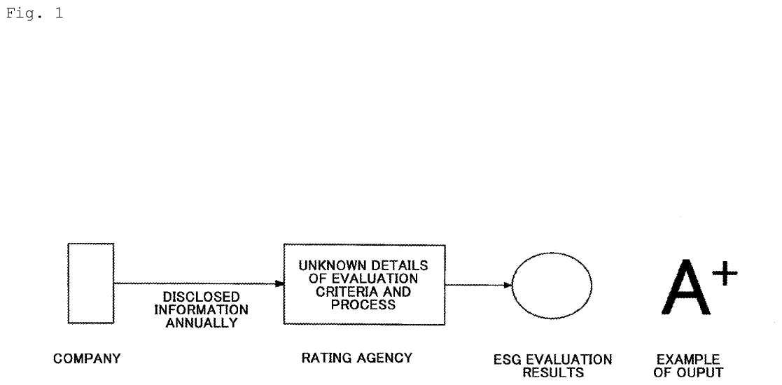

FIG. 1 illustrates a conventional evaluation method for comparison with a social value evaluation method according to the present embodiment. As shown in FIG. 1, a rating agency performs evaluation with a process, which is unknown in detail, using available information as provided by a company once a year, for example, and announces an evaluation result in the prior art. The evaluation result is, for example, in a form of rating information, such as “A+”.

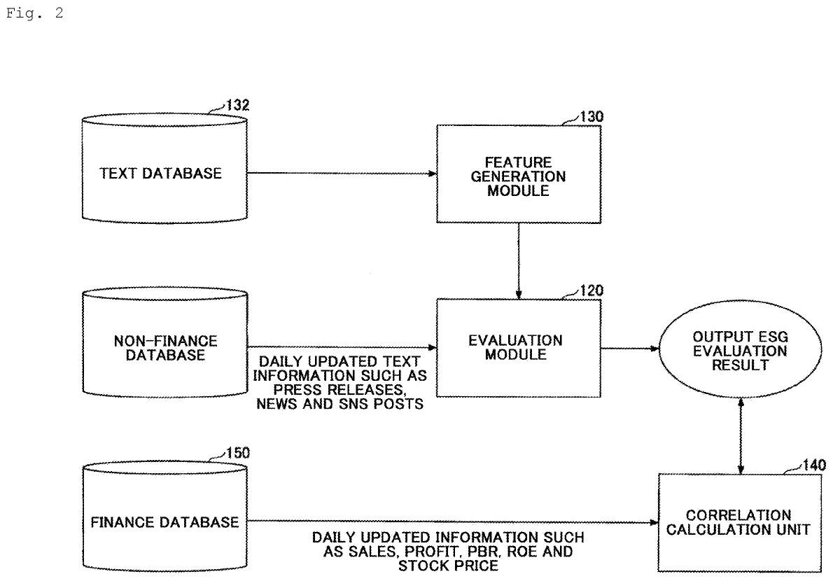

FIG. 2 is a diagram illustrating an operation outline of the social value evaluation device 100 according to the present embodiment. As shown in FIG. 2, a feature generation module 130 calculates a feature value relative to social value from text information (a plurality of sentences) related to the social value evaluation read from a text database 132.

An evaluation module 120 inputs text information including a plurality of sentences such as news, press releases, and posts on social networking services (SNS) acquired from, for example, a non-finance database; evaluates a relevance between the text information and the feature value generated by the feature generation module 130; and output the evaluation result. The evaluation result is an evaluation result of the social value for the target company.

For example, it is considered that, if a company discloses text information having high relevance to the feature value obtained from text information describing social value goals as daily activities in press releases and news, it has a higher social value.

A correlation calculation unit 140 inputs a plurality of financial metrics (e.g. sales, profit, PBR, ROE or stock price) from a finance database 150, calculates a correlation between the metrices (financial information) and the evaluation results of the social value obtained by the evaluation module 120, and outputs a calculation result.

The correlation calculation unit 140 may be configured to output the evaluation result from the evaluation module 120 and each piece of the financial information in chronological order to provide visibility of the correlation therebetween.

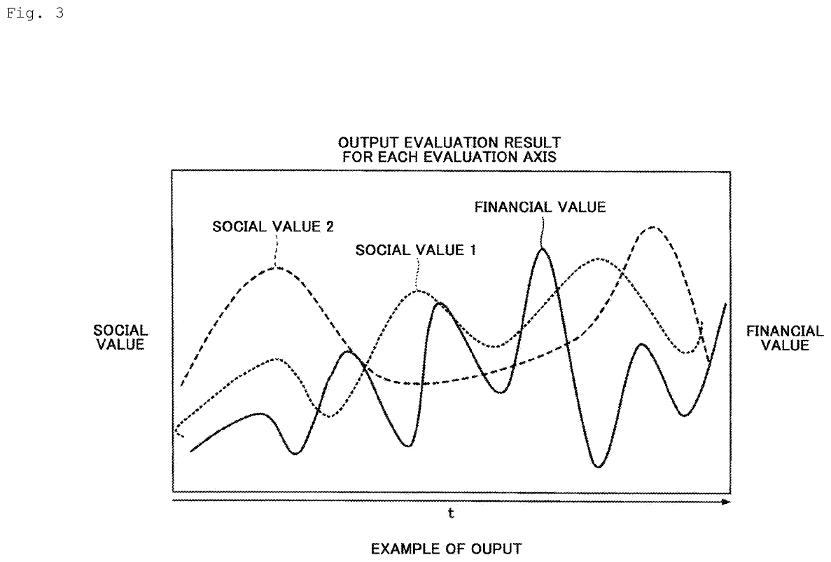

FIG. 3 shows an image of the output by the social value evaluation device 100. In the example shown in FIG. 3, “social value” and “financial value” are provided as evaluation axes, and time-series changes of “social value 1”, “social value 2” and “financial value” are shown respectively. This output allows a user to identify “social value 1” and “social value 2” and a correlation between “social value 1”/“social value 2” and “financial value.”

An exemplified configuration and operations of the social value evaluation device 100 will be described in detail hereinbelow.

(Configuration Example of Social Value Evaluation Device 100)

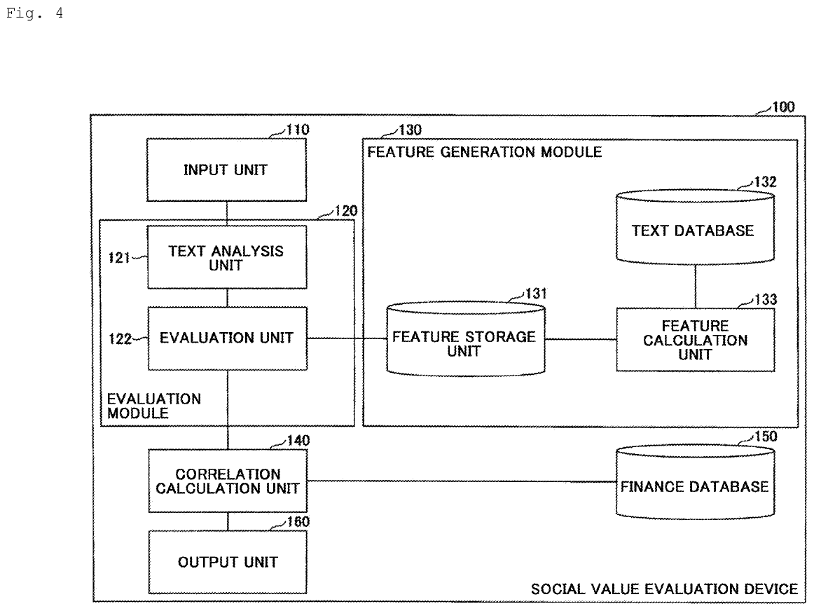

First, a configuration example of the social value evaluation device 100 will be described. FIG. 4 illustrates a detailed configuration example of the social value evaluation device 100. As shown in FIG. 4, the social value evaluation device 100 includes an input unit 110, an evaluation module 120, a feature generation module 130, a correlation calculation unit 140, a finance database 150, and an output unit 160.

The evaluation module 120 includes a text analysis unit 121 and an evaluation unit 122. The feature generation module 130 includes a feature storage unit 131, a text database 132, and a feature calculation unit 133.

Operations of the evaluation module 120, the feature generation module 130 and the correlation calculation unit 140 are summarized as described with reference to FIG. 2. The operations of the respective units constituting the social value evaluation device 100 will be described in detail with an operation example described later.

<Exemplified Hardware Configuration>

The social value evaluation device 100 can be implemented, for example, by causing a computer to execute a program. The computer may be a physical computer or a virtual machine on a cloud.

In other words, the social value evaluation device 100 can be implemented by executing a program corresponding to the processing executed by the social value evaluation device 100 using hardware resources such as a CPU and a memory that are built into the computer. The program can be recorded in a computer-readable recording medium (such as a portable memory) to be saved or distributed. It is also possible to provide the program through a network such as the Internet or email.

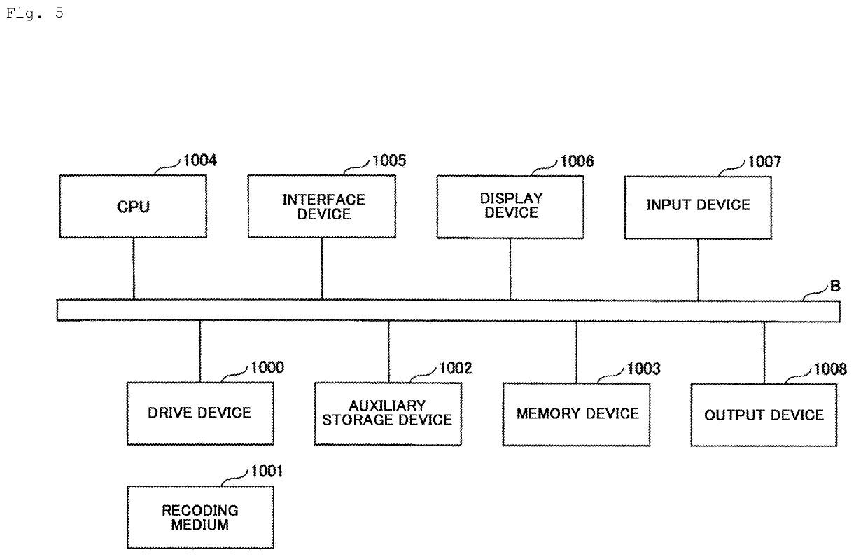

FIG. 5 is a diagram illustrating a hardware configuration example of the computer. The computer illustrated in FIG. 5 includes a drive device 1000, an auxiliary storage device 1002, a memory device 1003, a CPU 1004, an interface device 1005, a display device 1006, an input device 1007, and an output device 1008 which are connected to each other via a bus BS.

The program that implements processing in the computer is provided by, for example, a recording medium 1001 such as a CD-ROM or a memory card. When the recording medium 1001 having the program stored therein is set in the drive device 1000, the program is installed in the auxiliary storage device 1002 from the recording medium 1001 via the drive device 1000. However, the program need not necessarily be installed from the recording medium 1001 and may be downloaded from another computer via a network. The auxiliary storage device 1002 stores the installed program and also stores necessary files and data, for example.

The memory device 1003 reads and stores the program from the auxiliary storage device 1002 when there is an instruction to start the program. The CPU 1004 implements functions related to the social value evaluation device 100 according to the program stored in the memory device 1003. The interface device 1005 is used as an interface for connection to a network, serving as a transmission unit and a receipt unit. The display device 1006 displays, for example, a graphical user interface (GUI) according to a program. The input device 1007 is constituted by a keyboard and a mouse, buttons or a touchscreen, and is used for inputting various operation instructions. The output device 1008 outputs a calculation result.

(Operation Example of Social Value Evaluation Device 100)

Exemplified operations of the social value evaluation device 100 will be described next. Hereinafter, the social value evaluation will be performed for a given company (“evaluation target company”).

In the present embodiment, a feature value is generated from text information on social value evaluation and stored. This stage is called a “feature value generation phase.” The social value of the evaluation target company is evaluated using the stored feature value. This stage is called an “evaluation phase.” Each of the feature value generation phase and the evaluation phase will be described below.

(Feature Value Generation Phase)

The text database 132 in the feature generation module 130 stores, for example, a plurality of sentences representing goals for activities increasing a social value. More specifically, 169 target sentences for SDGS are stored, for example. Targets or goals may be called social value indices.

The feature calculation unit 133 inputs a plurality of sentences read from the text database 132, and executes morphological analysis of each sentence. Keywords can be obtained from an input sentence by morphological analysis. Any technique may be used for morphological analysis can be adopted, for example, natural language processing (NLP) such as TF-IDF, co-occurrence analysis, or dependency parsing, or text mining. Further, morphological analysis tools such as Mecab, JUMAN, and ChaSen may be used.

Instead of extracting keywords from the text information as described above, keywords may be set subjectively (manually).

In this embodiment, the feature calculation unit 133 generates 109 feature values consisting of several keywords from the 169 target sentences of the SDGS. The feature calculation unit 133 generate a feature value consisting of a vector from the feature values (which may be called “targets”) consisting of several keywords using pre-learned word-embedding vectors such as, for example, Word2Vec, GloVe, and fastText. Averaging or normalization among several keywords may be appropriately adopted.

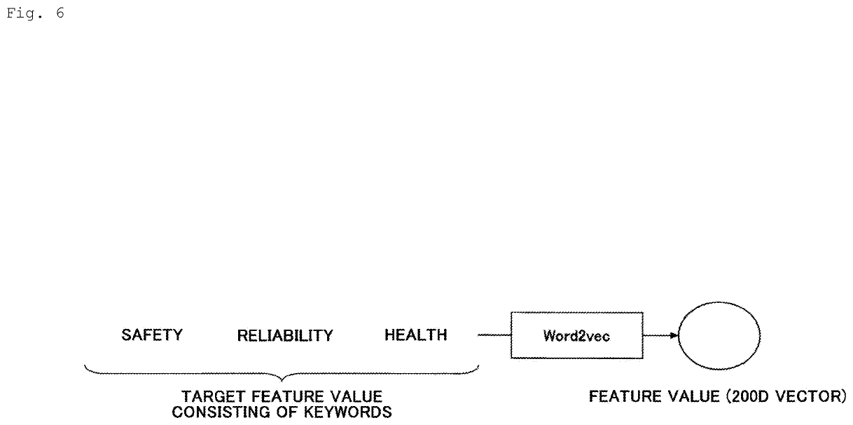

FIG. 6 shows an image in a case where a vector of the feature value is generated using the Word2Vec algorithm. In the example shown in FIG. 6, a feature value (about 200D vector) is obtained by the Word2Vec from one target feature value consisting of three keywords, “Safety”, “Reliability” and “Health.”

The feature value obtained by the feature calculation unit 133 is stored in the feature storage unit 131. For example, the feature storage unit 131 stores a target feature value (several keywords) and a feature amount (vector) obtained from the target feature value for each target.

(Evaluation Phase)

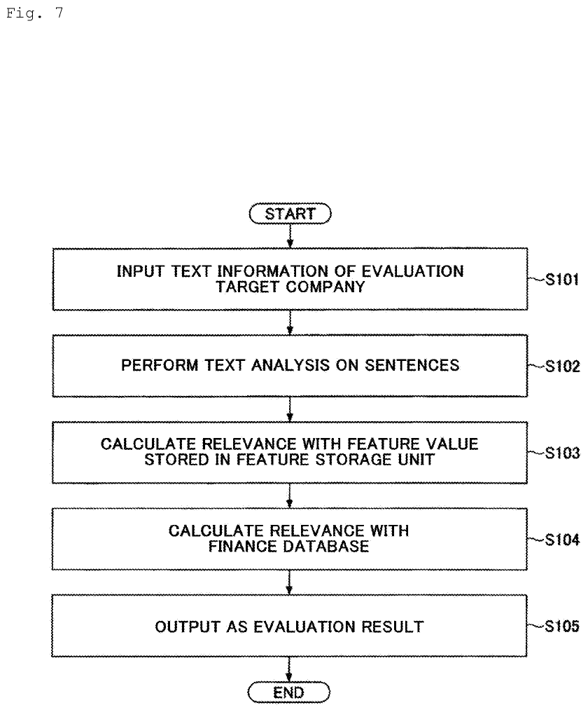

The exemplified operation of the social value evaluation device 100 in the evaluation phase will be described with reference to the flowchart illustrated in FIG. 7. Order of the processing shown in FIG. 7 is a mere example, and the processing may be performed in any order as long as the evaluation result can be calculated. Further, a plurality of processes may be executed in parallel.

<S101>

In S101 (Step 101), the input unit 110 inputs the text information on the evaluation target company. The text information is information obtained in real time for the evaluation target company. The text information may be any text information on the evaluation target company, including but not limited to press release, news, and SNS posts. In this embodiment, it is assumed that the input information is the news on the evaluation target company provided by the PR agency.

<S102>

In S102, the text analysis unit 121 in the evaluation module 120 preforms text analysis on the text information (a.k.a. “sentence” or “document”) input in S101.

Specifically, in the same manner as the method described in “feature amount generation phase”, for example, the text analysis unit 121 performs morphological analysis of the input text to generate a feature value using a word-embedding vector for one or more keywords obtained by the morphological analysis.

<S103>

In S103, the evaluation unit 122 calculates a relevance (specifically, similarity) between the feature value obtained by the text analysis unit 121 and the feature value read from the feature storage unit 131.

For example, assuming that 109 feature values (vectors) corresponding to 109 targets are stored in the feature storage unit 131, the evaluation unit 122 calculates the similarity between each of the 109 feature values and the feature values obtained by the text analysis unit 121.

In the similarity calculation, any method may be used as long as the similarity between two pieces of information can be calculated; for example, cosine similarity can be adopted. In a case where the cosine similarity is used, the similarity between a feature value x and a feature value y can be calculated by the following equation:

cos(x,y)=x·y/|x|×|y|

For example, the evaluation unit 122 extracts any number of keywords having especially high similarity from the input text (news) for each feature value stored in the feature storage unit 131. Averaged or normalized similarity can be similarity as the calculation result.

For example, the evaluation unit 122 may extract ten keywords. In this case, when a feature value of each of ten keywords is defined as a feature value 1, a feature value 2, . . . a feature value 9, and a feature value 10, and a feature value corresponding to a specific target A and stored in the feature storage unit 131 is denoted by a feature value A, the evaluation unit 122 calculates similarity 1 between the feature value 1 and the feature value A, similarity 2 between the feature value 2 and the feature value A, . . . similarity 9 between the feature value 9 and the feature value A, and similarity 10 between the feature value 10 and the feature value A.

For example, the evaluation unit 122 calculates an average value, a minimum value, and a maximum value of the similarities 1 to 10 for the target A, and outputs them as the calculation result relative to the target A. Such a calculation method is a mere example.

<S104>

In S104, the correlation calculation unit 140 calculates a correlation between the evaluation result obtained by the evaluation unit 122 and the financial information of the evaluation target company read from the finance database 150.

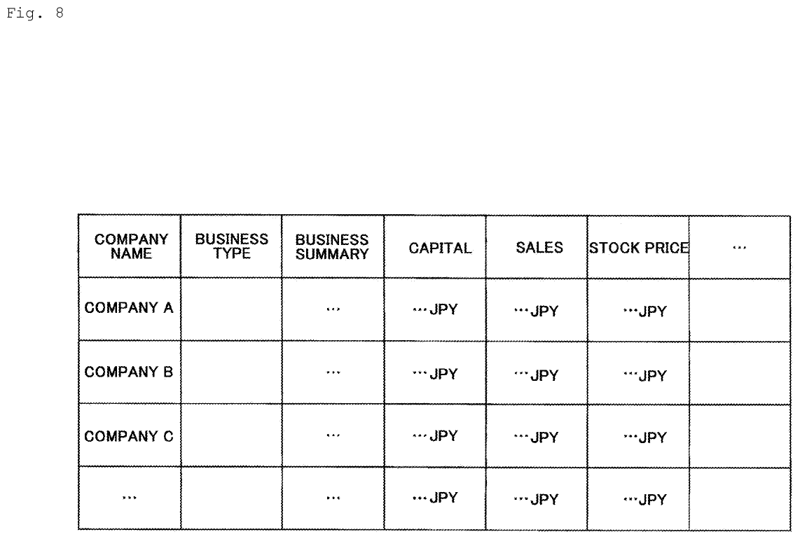

The finance database 150 stores information, for example, business type, sales, stock price, ROE and PBR. For sales, stock price, ROE and PBR, for example, information from the past to the present is stored in chronological order, that is, the latest information is always stored. FIG. 8 illustrates an example of the information stored in the finance database DB50.

For the correlation calculation, for example, a correlation coefficient between the similarity which is the result of the social value evaluation and the financial information may be calculated. Correlation analysis can find out a correlation, for example, a stock price is higher in a case where similarity to a certain target is high.

<S105>

The output unit 160 outputs the evaluation result. The evaluation result may be output as, for example, a graphical representation on a user interface (UI) screen or a sequence of numerical values. In a case where a sequence of numerical values is output, another device may display a graphical representation of the numerical values.

The output evaluation result may be similarity (e.g. similarity for each target) calculated by the evaluation module 120; similarity and finance information obtained from the finance database 150; a correlation value calculated by the correlation calculation unit 140; similarity, correlation and finance information; or alternatively, other information.

The information may be aggregated and then output. For example, 109 targets may be grouped into 17 SDGs and output.

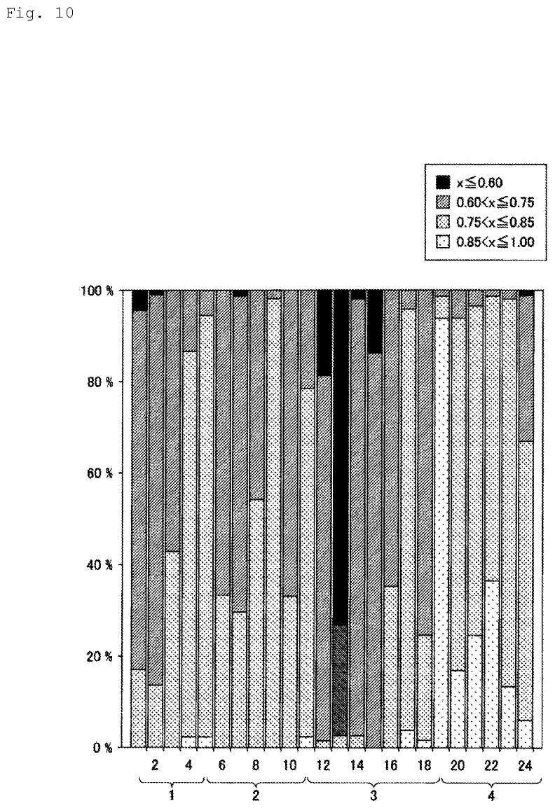

FIGS. 10 to 13 show output examples. For convenience of representation, each example presents only a part of the output screen.

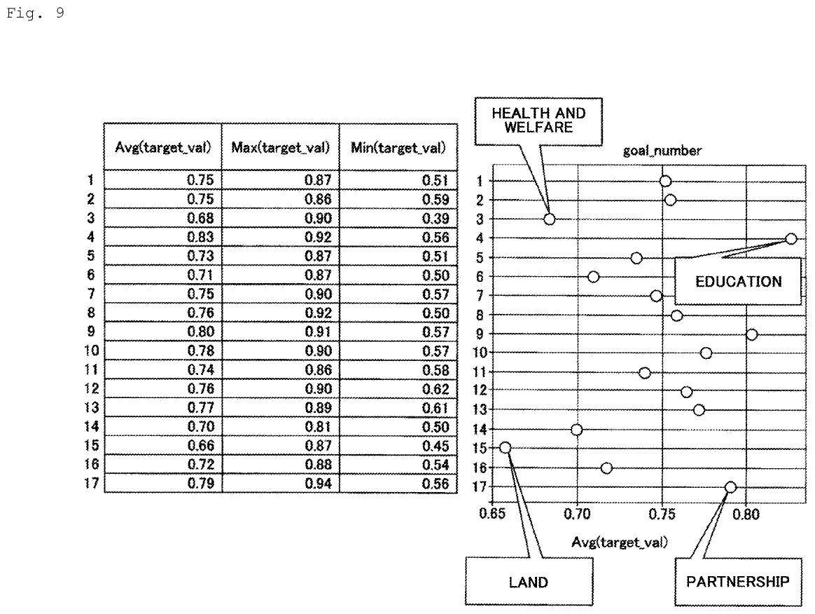

FIG. 9 shows an example in which 109 targets are grouped into 17 SDGs, presenting the average value (Avg), the maximum value (Max) and the minimum value (Min) of similarity (pieces of similarity corresponding to several keywords) for each goal.

1 to 17 each corresponds to Sustainable Development Goals (SDGs) including, for example, “Goal 1: End poverty in all its forms everywhere” in accordance with the provisional translation of the Ministry of Internal Affair and Communications (MIC). When outputting from the social value evaluation device 100, only a legend may be displayed instead of full text, i.e. “1: NO POVERTY.” FIG. 9 shows the numbers of goals, however the legend such as “1: NO POVERTY” may be presented for each goal number.

In the example on the left side of FIG. 9, the average value (Avg), the maximum value (Max) and the minimum value (Min) for each goal are tabulated; the shading or color of each column may be changed according to the magnitude of the value. For example, the higher the value is, the darker the color may be.

In the example on the right side of FIG. 9, the average value is indicated by O at a position in a horizontal direction intersected with a line (in a vertical direction) corresponding to each goal. It is also possible to change the color of filling the O mark for each goal.

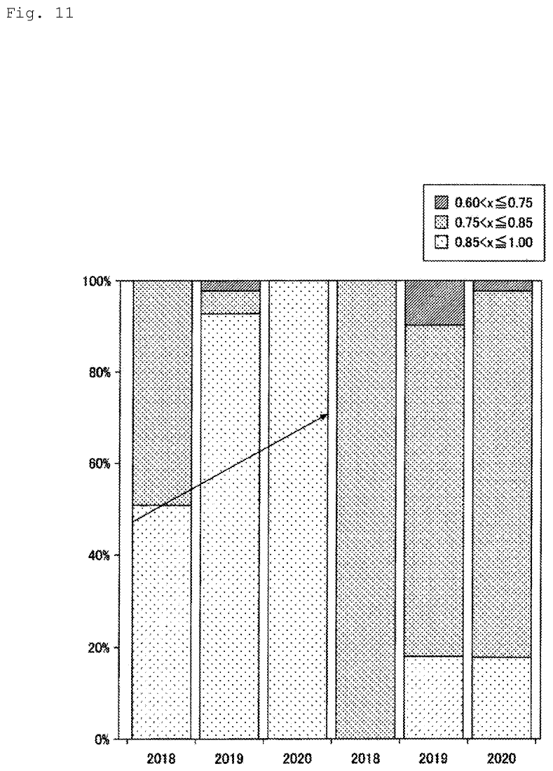

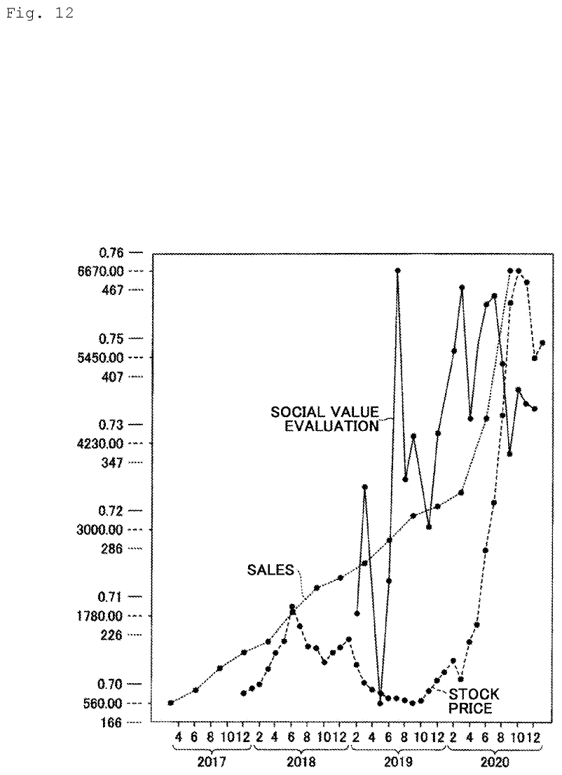

In the example shown in FIG. 10, a ratio of values in a plurality of similarities is displayed for each target number indicated on the horizontal axis. In FIG. 10, a range of the ratio is distinguished by the halftone dot meshing, but it may be distinguished by different colors. In the example shown in FIG. 10, the horizontal axis indicates the number of the goal corresponding to a plurality of target numbers. In the example shown in FIG. 11, the chronological change of the evaluation result for each target is shown. In the example shown in FIG. 12, the evaluation result and the financial information are displayed in chronological order.

### Advantageous Effects of Embodiment

As described above, the social value evaluation device 100 according to the present embodiment enables that, regardless of the public information such as a company annual report, the social value of the company relative to various evaluation axes can be evaluated from daily distributed text information such as press releases, news and SNS posts.

Further, various evaluation axes can be set, and concrete implementation of social values, such as the SDGs, can be evaluated.

Further, since evaluation is performed by inputting text information on the company, real-time evaluation in accordance with the actual corporate activities is available. Thus, the real-time evaluation can enable the correlation analysis with daily updated financial information such as stock price. Further, evaluation and analysis can be performed on the basis of business type and scalable implementation.

### Conclusion of Embodiment

The present specification discloses, at least, a social value evaluation device, a social value evaluation method, and a program according to each of the following Items.

(Item 1)

A social value evaluation device, including:
a feature value generation unit configured to generate a feature value from text information on social value evaluation;
an input unit configured to input text information on an evaluation target;
an evaluation unit configured to evaluate a relevance between the feature value and the text information input by the input unit; and
an output unit configured to output an evaluation result from the evaluation unit.

(Item 2)

The social value evaluation device according to Item 1, wherein the evaluation unit is configured to evaluate the relevance by calculating similarity between a feature value generated from the text information input by the input unit and a feature value generated by the feature value generation unit.

(Item 3)

The social value evaluation device according to Item 1 or 2, further including:
a relevance calculation unit configured to calculate a relevance between the evaluation result from the evaluation unit and financial information of the evaluation target.

(Clause 4)

The social value evaluation device according to any one of Items 1 to 3, wherein the output unit is configured to output information indicating the evaluation result from the evaluation unit for each social value index.

(Clause 5)

The social value evaluation device according to any one of Items 1 to 4, wherein the output unit is configured to output information indicating the evaluation result from the evaluation unit and financial information of the evaluation target in chronological order.

(Clause 6)

A social value evaluation method executed by a social value evaluation device, the method including:
generating a feature value from text information on social value evaluation;
inputting text information on an evaluation target; evaluating a relevance between the feature value and the text information input in the inputting; and
outputting an evaluation result obtained in the evaluating.

(Clause 7)

A program for causing a computer to serve as each unit of the social value evaluation device according to any one of Items 1 to 5.

Although the embodiment has been described above, the present invention is not limited to the specific embodiment, and various modifications and changes can be made within the scope of the present invention disclosed in the accompanying claims.

### REFERENCE SIGNS LIST

110 Social value evaluation device
110 Input unit
120 Evaluation module
121 Text analysis unit
122 Evaluation unit
130 Feature generation module
131 Feature storage unit
132 Text database
133 Feature calculation unit
140 Correlation calculation unit
150 Finance database
160 Output unit
1000 Drive device
1001 Recording medium
1002 Auxiliary storage device
1003 Memory device
1004 CPU
1005 Interface device
1006 Display device
1007 Input device

1. A social value evaluation device comprising a processor configured execute operations comprising:
retrieving first textual data of an evaluation target entity on nonmonetary social values from a first database;
generating a feature value from the first textual data of the evaluation target entity;
retrieving, as input, second textual data on a performance result of execution by the evaluation target entity from a second database;
determining relevance data between the feature value and the second textual data as an evaluation result; and
transmitting the evaluation result over a network to an application configured to display the evaluation result.

2. The social value evaluation device according to claim 1, wherein the determining further comprises determining the relevance data by calculating similarity between the feature value generated from the second textual data and the feature value.

3. The social value evaluation device according to claim 1, further comprising:
calculating the relevance data between the evaluation result and financial data of the evaluation target entity.

4. The social value evaluation device according to claim 1, wherein the transmitting further comprising causing display of information indicating the evaluation result each social value index of a plurality of social value indices.

5. The social value evaluation device according to claim 1, wherein the transmitting further comprises causing the application to display the evaluation result and financial information of the evaluation target entity in chronological order.

6. A method comprising:
retrieving first textual data of an evaluation target entity on nonmonetary social values from a first database;
generating a feature value from first textual data of the evaluation target entity;
receiving, as input, second textual data on a performance result of execution by evaluation target entity from a second database;
determining relevance data between the feature value and the second textual data as an evaluation result; and
transmitting the evaluation result over a network to an application configured to display the evaluation result.

7. A computer-readable non-transitory recording medium storing computer-executable program instructions that when executed by a processor cause a computer to execute operations comprising:
retrieving first textual data of an evaluation target entity on nonmonetary social values from a first database;
generating a feature value from the first textual data of the evaluation target entity;
retrieving, as input, second textual data on a performance result of execution by the evaluation target entity from a second database;
determining relevance data between the feature value and the second textual data as an evaluation result; and
transmitting an evaluation result over a network to an application configured to display the evaluation result.

8. The social value evaluation device according to claim 1, wherein the first textual data includes social media content about the evaluation target entity, and the second textual data describe periodic financial performance data of the evaluation target entity.

9. The social value evaluation device according to claim 1, wherein the relevance data indicates relevance between a social value of the evaluation target entity and a financial value of the evaluation target entity at a time, and the evaluation result includes a change in the relevance data over time.

10. The method according to claim 6, wherein the determining further comprises determining the relevance data by calculating similarity between the feature value generated from the second textual data and the feature value.

11. The method according to claim 6, further comprising:
calculating the relevance data between the evaluation result and financial data of the evaluation target entity.

12. The method according to claim 6, wherein the transmitting further comprising causing display of information indicating the evaluation result each social value index of a plurality of social value indices.

13. The method according to claim 6, wherein the transmitting further comprises causing the application to display the evaluation result and financial information of the evaluation target entity in chronological order.

14. The method according to claim 6, wherein the first textual data includes social media content about the evaluation target entity, and the second textual data describe periodic financial performance data of the evaluation target entity.

15. The method according to claim 6, wherein the relevance data indicates relevance between a social value of the evaluation target entity and a financial value of the evaluation target entity at a time, and the evaluation result includes a change in the relevance data over time.

16. The computer-readable non-transitory recording medium according to claim 7, wherein the determining further comprises determining the relevance data by calculating similarity between the feature value generated from the second textual data and the feature value.

17. The computer-readable non-transitory recording medium according to claim 7, the computer-executable program instructions when executed further causing the computer to execute operations comprising:
calculating the relevance data between the evaluation result and financial data of the evaluation target entity.

18. The computer-readable non-transitory recording medium according to claim 7, wherein the transmitting further comprising causing display of information indicating the evaluation result each social value index of a plurality of social value indices.

19. The computer-readable non-transitory recording medium according to claim 7, wherein the first textual data includes social media content about the evaluation target entity, and the second textual data describe periodic financial performance data of the evaluation target entity.

20. The computer-readable non-transitory recording medium according to claim 7, wherein the relevance data indicates relevance between a social value of the evaluation target entity and a financial value of the evaluation target entity at a time, and the evaluation result includes a change in the relevance data over time.
